(19) United States
(12) Patent Application Publication
(10) Pub. No.: US 2026/0227651 A1
(43) Pub. Date: Aug. 6, 2026

(54) METHOD AND APPARATUS FOR MEASURING FACE FORM ANGLE OF SPECTACLES AND COMPUTER PROGRAM PRODUCT

(71) Applicant: Rodenstock GmbH, Muenchen (DE)

(72) Inventors: Wolfgang Hauk, Augsburg (DE); Lukas Gromann, Freising (DE)

(21) Appl. No.: 19/147,788

(22) PCT Filed: Dec. 18, 2023
(86) PCT No.: PCT/EP2023/086424

§ 371 Date: Jul. 14, 2025

(30) Foreign Application Priority Data
Jan. 20, 2023 (DE) 10 2023 200 424.0

(51) Int. Cl. G02C 13/00; G01B 11/24

(52) U.S. Cl. CPC G02C 13/003; G01B 11/2408

(57) ABSTRACT

In a method for measuring a face form angle of spectacles, arranging spectacles, which have a first spectacle lens and a second spectacle lens, on a spectacle receptacle is carried out. The spectacle lens surfaces of both spectacle lenses of the spectacles are scanned using a scanner for generating first surface position data points of the first spectacle lens and second surface position data points of the second spectacle lens. The first surface position data points of the first spectacle lens are mirrored onto the second surface position data points of the second spectacle lens with respect to a central plane between the two spectacle lenses such that the first and second surface position data points of both spectacle lenses are superimposed. A fitting function is ascertained as a surface function through the superimposed surface position data points of both spectacle lenses. The face form angle is ascertained using the surface function through the superimposed surface position data points of both spectacle lenses.

### TECHNICAL FIELD

The invention relates to a method and apparatus for measuring the face form angle of spectacles and a computer program product.

### BACKGROUND

In order to measure and check the face form angle, it is known to check the surface of finished spectacles by means of a laser scanning operation. For this purpose, e.g., the Rodenstock Centering Analyzer (abbr.: RCA) may be used. The RCA comprises a laser scanner which ascertains a height profile of the spectacle surface by means of laser beams reflected from the spectacles. From this height profile, the face form angle of the spectacles can be ascertained.

The face form angle (abbr.: FFA), in accordance with DIN EN ISO 8624 and DIN EN ISO 58208, is defined as the angle between the frame plane and the right and left lens plane, respectively. Here, the lens plane is defined as the plane through the horizontal and vertical center lines in the right and left box system of the spectacle frame, respectively. The frame plane is defined as the plane which runs through the vertical center lines, in parallel with each other, of the box systems specifying the right and left lens planes of a spectacle frame. Here, the box system is also defined in the above-mentioned standards. The face form angle, the frame plane, the lens plane and the box system constitute standardized terms familiar to a person skilled in the art.

The face form angle may be regarded as a measure of the roundness of a spectacle frame and plays a role in centering spectacle lenses and in calculating individualized ophthalmic spectacle lenses.

The previously known method for measuring and checking the face form angle works relatively well for diffusely reflective surfaces. A difficulty with spectacle lenses is due to their reduced diffuse reflection, as well as their transparency. The challenge is in particular to recognize and filter out the reflection signals relevant for measurement. Here, reflection signals from the front and back of the spectacle lens are to be distinguished from each other. In addition, noise and measurement artifacts, which are caused, e.g., by parts of the spectacle frame itself, should be filtered out.

Thus, the reflection signals measured by the laser are sometimes very widely scattered, e.g. due to interfering reflections, back surface reflections and/or weak reflections in plastic lenses with a refractive index of 1.5.

The method therefore only works satisfactorily for some of the spectacle lenses, while it does not provide any usable results for around a third of the spectacle lenses. For these spectacle lenses, the FFA must be, e.g., remeasured manually.

### SUMMARY

The invention is therefore based on the object of providing a possibility to ascertain the face form angle of spectacles more reliably.

This object is achieved by the subject matters of the independent claims. Preferred embodiments are the subject matters of the dependent claims.

One aspect relates to a method for measuring the face form angle of spectacles, wherein the spectacles, which have a first spectacle lens and a second spectacle lens, are arranged on a spectacle receptacle. The spectacle lens surfaces of both spectacle lenses of the spectacles are scanned by means of a scanner for generating first surface position data points of the first spectacle lens and second surface position data points of the second spectacle lens. The first surface position data points of the first spectacle lens are mirrored onto the second surface position data points of the second spectacle lens with respect to a central plane between the two spectacle lenses such that the first and second surface position data points of both spectacle lenses are superimposed. A fitting function, in particular a fitting polynomial, is ascertained as a surface function through the superimposed surface position data points of both spectacle lenses. The face form angle is ascertained by means of the surface function through the superimposed surface position data points of both spectacle lenses.

In addition to a fitting polynomial, another function may also be used as a fitting function, e.g. straight lines and/or parabolas as special fitting polynomials, a function with at least one e-function, with at least one Fourier series, with at least one Gaussian curve, and/or a similar numerical approximation. Fitting polynomials have proven to be particularly suitable, since they are easy to handle mathematically and usually achieve sufficient accuracy.

The method is performed on finished spectacles and/or complete spectacles, i.e. on spectacles having spectacle lenses made of plastic or glass inserted into the spectacle frame of the spectacles. For performing the method, e.g., the Rodenstock Centering Analyzer, which is abbreviated with RCA, may be used.

First, the spectacles are arranged on a measurement setup in the scanning field of the scanner. For this purpose, the spectacle receptacle is used, which may have, e.g., a centering piece on which the spectacles are arranged with a predetermined orientation relative to the scanner. Here, the spectacles may be arranged on the spectacle receptacle such that the spectacle lens surfaces face the scanner. This means that the side of the spectacle lenses facing away from the eyes of a spectacle wearer of the spectacles, also called the front side, faces the scanner. These sides of the spectacle lenses facing away from the eyes of a spectacle wearer are referred to as spectacle lens surfaces.

As a scanner, a laser scanner may be used, i.e. a scanner which scans the spectacle lens surfaces by means of laser light. For this purpose, in particular a line laser scanner is suitable, e.g. the laser scanner ScanCONTROL 2900-100/BL by Micro-Epsilon. The scanner emits a scanning light onto the spectacle lens surfaces from which the scanning light is reflected. The scanning light thus reflected is registered as scanning signals by the scanner. The light reflections of the scanning light thus registered may be assigned position data points which may be determined, e.g., by means of triangulation. For this purpose, the scanner may be arranged in a well-defined and/or calibrated position relative to the spectacles and/or spectacle receptacle. In some embodiments, the scanner may create the position data points autonomously (e.g. by means of triangulation).

The position data points of the reflection signals reflected from the spectacle lens surfaces are stored as the surface position data points. Scanning signals reflected from the first spectacle lens and/or scanning signals which are reflected from a first spectacle half of the spectacles which comprises the first spectacle lens are acquired as first surface position data points and further processed. Scanning signals reflected from the second spectacle lens and/or scanning signals which are reflected from a second spectacle half of the spectacles which comprises the second spectacle lens are acquired as second surface position data points and further processed. Here, the distinction between the surface position data points into first and second surface position data points may be made solely on the basis of whether the reflection location of the scanning signals is arranged in the first or second spectacle half, e.g. in the left or right half of the spectacles arranged on the spectacle receptacle.

The surface position data points thus obtained at first do not contain exclusively position data points which are actually arranged on the spectacle lens surfaces. Actually, the first and/or second surface position data points may at first still contain interfering signals, for example position data points which have been generated by reflections of the spectacle frame and/or reflections at the spectacle lens back surface. Here, the spectacle lens back surface is arranged on the backside of the spectacle lens, which faces the eyes of a spectacle lens wearer in a position of use of the spectacles.

By means of the scanner, the first and second surface position data points can be generated so as to be arranged sequentially on at least one scanning line. This scanning line may, e.g., run across at least one spectacle lens surface. The scanning line may extend approximately horizontally across the spectacle lens and/or the spectacle lenses (at least in the position of use of the spectacles). In other words, the scanning line may run, e.g., transversely across both spectacle lenses here. The scanning line may extend in the line direction across most of both the first spectacle lens and the second spectacle lens. This means that the surface position data points overlap at least 50% of the spectacle lens surfaces of the first and second spectacle lenses in the line direction of the scanning line. Before the nasal and/or temporal edges of both spectacle lenses, the scanning line may be interrupted and/or cut off to reduce interfering reflections caused by the spectacle frame. For this purpose, surface position data points arranged at the nasal and/or temporal edges of both spectacle lenses may, e.g., be automatically discarded.

The first and second surface position data points may be stored as coordinates of a coordinate system. Each surface position data point thus obtained is assigned either the first or the second spectacle lens, so that it is stored as either a first or a second surface position data point. Here, e.g., the first spectacle lens may be formed as the left spectacle lens of the spectacles and the second spectacle lens may be formed as the right spectacle lens. Alternatively, the assignment is made vice versa.

They may be further processed as one dataset. The further evaluation of the first and second surface position data points thus obtained may be performed in a computer-aided manner.

By mirroring the first surface position data points onto the second surface position data points, the number of the data points arranged in one measurement half can be increased, e.g. approximately doubled. As a result, the accuracy of the measurement can be significantly increased, increasing the reliability of the measurement method.

The mirroring is carried out with respect to the central plane which, e.g., may be fixedly defined and/or which divides the spectacles approximately symmetrically into two halves. In the position of use when wearing the spectacles, the central plane may be arranged, e.g., as an approximately vertical plane which runs perpendicularly to the frame bridge of the spectacle frame of the spectacles. The central plane may be predefined relative to the spectacle receptacle on which the spectacles are arranged during the measurement.

If the spectacles are perfectly oriented relative to the spectacle receptacle, the first surface position data points are mirrored onto the second surface position data points almost coincidently. In any case, the number of the position data points is increased by the mirroring, whereby a more stable surface function through the superimposed surface position data points can be applied.

In this way, a superimposed dataset of surface position data points can be obtained in which the first and second surface position data points are superimposed in the second spectacle half. In the further processing of the surface position data points, all of the surface position data points may still remain indicated as either first or second surface position data points.

As a surface function, the fitting function through the superimposed surface position data points is ascertained. Here, a second-degree fitting polynomial is preferably used which usually fits well with the curvature of the front surface of the spectacle lenses which are made to resemble a spherical surface and/or formed to be approximately spherical. When ascertaining the fitting function, it may be taken into account at which angle the laser scanner is arranged relative to the spectacles and/or spectacle receptacle. Here, it may be taken into account in particular at which angle an optical axis of the laser scanner is incident on the spectacle lens surfaces of the spectacles arranged in the spectacle receptacle.

Preferably, the optical axis of the laser scanner is incident on the spectacle lens surfaces of the spectacles arranged in the spectacle receptacle approximately perpendicularly, e.g. at an angle of about 80° to about 100°.

The fitting function may be ascertained, e.g., by linear regression. The fitting function is used as a surface function of the spectacle lens. The face form angle may be calculated on the basis of the surface function of the spectacle lenses, since the surface function represents the course of the surface of the spectacle lens.

Since the surface function may change during processing steps of the surface position data points described below, it is also referred to below as the “current” surface function. This expresses that, after all, the fitting function created only on the basis of the simply superimposed surface position data points does not necessarily have to be used as the surface function. Rather, a modified fitting function may be newly calculated, e.g., after filtering the surface position data points, and this modified fitting function may be used as the current surface function, e.g. for calculating the face form angle and/or for further data processing.

By the method, either only one face form angle may be calculated, or both the right and left face form angles are calculated. In order to calculate the face form angle of the first spectacle lens, e.g., the fitting function may be mirrored back onto the first spectacle half, from which the first surface position data points have been measured, with respect to the central plane.

Alternatively, the first surface position data points (e.g. remaining after filtering) may be mirrored back into the first spectacle half, and a first fitting function through the first surface position data points is applied and taken into account when calculating the first face form angle.

Thus, when calculating the face form angle, after all, either a single fitting function may be used as a surface function (e.g. for both spectacle lenses), or a first and a second fitting function are ascertained as a first and a second surface function for the first and second spectacle halves. Then, the first and second face form angles may be ascertained on the basis of the first and second surface functions.

By the method, the symmetry of the spectacles is utilized to increase the number of the surface position data points, thus making the calculation more stable. Since most spectacles produced, i.e. more than 95% of the spectacles produced, have a same base curve of the lenses on the left and on the right, very similar measurement values are expected for the right and left spectacle lenses. Here, the measurement values may differ, e.g., only by the noise which has been caused by measurement errors. By mirroring the first surface position data points, the dataset is enriched and thus becomes more robust for the further processing.

In one embodiment, in the superimposed surface position data points, the first surface position data points are tilted with respect to the second surface position data points such that the first and second surface position data points are arranged more closely to the ascertained surface function. Since in practice, the spectacles are not always arranged to be perfectly oriented on the spectacle receptacle, it may occur that the first surface position data points are not imaged consistently with the second surface position data points when being mirrored. In order to compensate for this, the tilting of the first surface position data points with respect to the second surface position data points is carried out. Here, the aim of the tilting may be to superimpose the first and second surface position data points as consistently as possible. For this purpose, a tilt of at most about 2° may be sufficient to significantly increase the overlap of the superimposed surface position data points. The magnitude of the tilt, i.e. the exact tilt angle, may depend on the degree of overlap of the surface position data points. The more accurately the surface position data points overlap after tilting, the more suitable the tilt angle used in tilting is for the further data processing.

In a further development, the tilt of the first surface position data points with respect to the second surface position data points is optimized in such a way that the superimposed first and second surface position data points are arranged as closely as possible to an optimized fitting function as the surface function through the surface position data points, superimposed over each other and tilted in an optimized manner, of both spectacle lenses. For this purpose, e.g., a best fit approach may be chosen to optimize the magnitude of the tilt, i.e. the tilt angle. By the tilt of the surface position data points thus optimized, asymmetrical resting of the spectacles on the spectacle receptacle can be almost compensated for. The first and second surface position data points may be arranged almost congruently and/or coincidently over each other after optimizing the tilt. Here, the measurement errors and/or noise signals contained in the surface position data points constitute an exception. On the basis of the superimposed surface position data points thus tilted in an optimized manner, the optimized fitting function is calculated. In turn, a second-degree fitting polynomial is preferably used for this purpose. The optimized fitting function is used as the surface function, e.g. when calculating the face form angle(s). This optimized tilt improves the superimposed dataset, turns it into an optimized dataset, and may accordingly lead to a more accurate and more reliable measurement result.

According to one embodiment, in a reduction step, individual surface position data points whose distance from the surface function is greater than a predetermined first maximum distance are removed from the superimposed and possibly tilted (e.g. in an optimized manner) surface position data points so as to obtain superimposed and reduced surface position data points. For the reduction step, either the superimposed surface position data points are used, or the surface position data points already superimposed and tilted are used, or preferably the surface position data points superimposed and tilted in an optimized manner are used. In the latter, the tilt is already optimized as described above. In order to eliminate “outliers” in the dataset, in the reduction step, those surface position data points which are further away from the current surface function than the predetermined maximum distance are removed from the (e.g. optimized) dataset. For this purpose, one of the fitting functions may be used as a surface function. In this way, as a surface function, e.g. the (simple) fitting function created on the basis of the superimposed surface position data points may be used, or the optimized fitting function, or also a reduced fitting function during iteration (cf. the processing steps described below). As a first predetermined maximum distance, e.g., a distance of about 0.1 mm to about 0.5 mm may be used, preferably of about 0.2 mm to about 0.4 mm. A first maximum distance of about 0.3 mm has empirically proven to be particularly suitable to effect a reasonable reduction and thus filtration of the surface position data points. Thus, all surface position data points which are spaced apart from the current surface function by more than 0.3 mm, e.g., are eliminated from the current dataset and not taken into account for further calculation.

In a further development, a reduced fitting function, in particular a reduced fitting polynomial, is ascertained as a surface function through the superimposed and reduced surface position data points of both spectacle lenses. After cleansing the dataset, that is, after removing the surface position data points arranged too far away during the reduction step, a fitting function through the remaining surface position data points is thus applied again. This fitting function may be designed as a second-degree polynomial and be referred to as a reduced fitting polynomial, since it is based on a reduced dataset of surface position data points.

In the following, the reduced fitting function is used as the current surface function. For example, the face form angle may be ascertained on the basis of the surface function thus obtained.

In a further development, at least the reduction step is iterated on the basis of the reduced fitting function as the surface function and on the basis of the superimposed and reduced surface position data points. During the iteration, in turn, individual surface position data points whose distance from the, now current, surface function, that is, from the reduced fitting function, is greater than the predetermined first maximum distance are removed. Here, the reduced dataset of surface position data points is further reduced, increasing the quality of the remaining surface position data points. On the basis of the surface position data points thus further reduced, a reduced fitting function through the remaining, reduced surface position data points is ascertained again. The reduction step may be iterated on the basis of the reduced fitting function newly calculated in each case until not a single surface position data point is spaced apart from the (current) reduced fitting function through the remaining superimposed and reduced surface position data points more than the first maximum distance. Then, the iteration may be terminated. By the iteration, effective filtration of the surface position data points is achieved.

Moreover, the iteration may comprise further method steps. For instance, in addition to the reduction step, the optimization of the tilt of the surface position data points may also be iterated with respect to each other. For example, the optimization of the tilt may first be iterated, then an optimized fitting function may be ascertained again, and subsequently, the reduction step is iterated.

Here, at least the reduction step may be iterated on the basis of the current surface function in each case, e.g. the reduced fitting function ascertained again or the optimized fitting function ascertained again, until a predetermined exact filtration of the surface position data points is achieved. The iteration may be carried out, e.g., according to the Newton method. The iterations may be terminated, e.g., when no more surface position data points further away from the current surface function, e.g. from the reduced or optimized fitting function, than the first maximum distance are ascertained during the reduction step.

In a further development of the embodiment with the reduction step, individual surface position data points whose distance from the surface function is greater than a predetermined second maximum distance are removed from the superimposed and reduced surface position data points, wherein the second maximum distance is designed to be smaller than the first maximum distance so as to obtain minimized surface position data points. This method step may be referred to as a minimization step. The second maximum distance may, e.g., be designed to be approximately half the first maximum distance. In the example, the second maximum distance may thus be about 0.15 mm. By this minimization of the reduced and superimposed surface position data points, a further filtration of the dataset is achieved, whereby a minimized dataset is obtained which only comprises the minimized (and still superimposed) surface position data points.

In a further development, a minimized fitting function, in particular a minimized fitting polynomial, is ascertained as the surface function through the minimized surface position data points of both spectacle lenses. The minimized fitting function may be used as the surface function ultimately used to calculate the face form angle. Alternatively, the reduction step and/or minimization step described above may additionally also be iterated on the basis of the minimized fitting function and on the basis of the minimized surface position data points. In practice, it has been found that a further iteration on the basis of the smaller second maximum distance hardly leads to improvements in the minimized dataset. Therefore, it is usually sufficient to perform the minimization only once and to use the minimized fitting function calculated once as the final surface function.

According to one embodiment, the face form angle is ascertained on the basis of the surface function which corresponds to one of the following fitting functions:
the optimized fitting function,
the reduced fitting function, or
the minimized fitting function.

The measurement result is more accurate and achieved the more of the method steps described above are performed. Ideally, the superimposed surface position data points are thus tilted with respect to each other, this tilt is optimized, an iterative reduction on the basis of the first maximum value is performed, and a minimization on the basis of the second maximum value is performed, and the minimized fitting function is used as a surface function. By this procedure, in practice, the face form angle of at least 97% of the measured spectacles could be determined correctly. Only in less than 3% of the spectacles measured, no satisfactory measurement result could be achieved in this way. Thus, the reliability is significantly increased over the previously known method, according to which the face form angle could not be determined with sufficient accuracy for approximately one in three pairs of spectacles.

According to one embodiment, a fitting polynomial is ascertained as a fitting function. Depending on the embodiment, there is/are possibly ascertained and/or used:
a) an optimized fitting polynomial as an optimized fitting function, and/or
b) a reduced fitting polynomial as a reduced fitting function, and/or
c) a minimized fitting polynomial as a minimized fitting function.

Fitting polynomials can be mathematically handled most easily and are therefore particularly suitable for applying technically reasonable approximation curves at measurement points. It has been found that especially fitting polynomials are suitable as an approximation for the underlying problem of the invention.

According to one embodiment, prior to ascertaining the face form angle for the first spectacle lens, the remaining first surface position data points are mirrored back to the associated side of the spectacles. Here, these are the remaining first surface position data points of the current dataset, e.g. the optimized, reduced or minimized dataset. Through these mirrored-back first surface position data points, a first fitting function may be ascertained, e.g. a first minimized fitting function through the mirrored-back first minimized surface position data points. The first fitting function may be used as a first surface function for calculating the first face form angle of the first spectacle lens. The second surface position data points remaining in the second spectacle half after mirroring back, e.g. the minimized second surface position data points, may be used to ascertain a second fitting function, e.g. a second minimized fitting function. This second fitting function may be used as a second surface function for calculating the second face form angle of the second spectacle lens.

Alternatively, only the current fitting function, e.g. the optimized fitting function, the reduced fitting function or the minimized fitting function, may be mirrored back. In this way, the current fitting function can be used in both spectacle halves as first and second surface functions for calculating the first and second face form angles. However, mirroring back the remaining first surface position data points to the first spectacle half usually provides more reliable results when calculating the face form angles.

According to one embodiment, the surface position data points are ascertained two-dimensionally. The further evaluation, filtration and calculation may also be carried out two-dimensionally. This is sufficient for reliable measurement of the face form angle and reduces the workload in comparison to a three-dimensional calculation.

One aspect relates to an apparatus for measuring the face form angle of spectacles having a spectacle receptacle for receiving the spectacles which have a first spectacle lens and a second spectacle lens. A scanner is configured for scanning the spectacle lens surfaces of both spectacle lenses of the spectacles arranged on the spectacle receptacle and for generating first surface position data points of the first spectacle lens and second surface position data points of the second spectacle lens. A mirroring module is configured to mirror the first surface position data points of the first spectacle lens onto the second surface position data points of the second spectacle lens with respect to a central plane between the two spectacle lenses such that the first and second surface position data points of both spectacle lenses are superimposed. A fitting function ascertaining module is configured to ascertain a fitting function as a surface function through the superimposed surface position data points of both spectacle lenses. A face form angle ascertaining module is configured to ascertain the face form angle by means of the surface function through the superimposed surface position data points of both spectacle lenses.

This apparatus may be designed to perform the method according to the above-described aspect. Therefore, the explanations regarding the apparatus also relate to the method and vice versa. As an apparatus, e.g., an RCA, that is, the Rodenstock Centering Analyzer, may be used. The RCA may have a computer and/or be connected to a computer on which the evaluation of the surface position data points can be performed.

The fitting function ascertaining module may be used to ascertain the fitting function through the superimposed surface position data points, to ascertain the optimized fitting function through the superimposed surface position data points tilted in an optimized manner, to ascertain the reduced fitting function through the superimposed and reduced surface position data points, and/or to ascertain the minimized fitting function through the minimized surface position data points.

In one embodiment, the apparatus has at least one of the following features:
a tilting module which is configured, in the superimposed surface position data points, to tilt the first surface position data points with respect to the second surface position data points such that the first and second surface position data points are arranged more closely to the ascertained surface function; and/or
an optimization module which is configured to optimize the tilt of the first surface position data points with respect to the second surface position data points in such a way that the superimposed first and second surface position data points are arranged as closely as possible to an optimized fitting function as the surface function through the surface position data points, superimposed over each other and tilted in an optimized manner, of both spectacle lenses; and/or
a reduction module which is configured, in a reduction step, to remove individual surface position data points whose distance from the surface function is greater than a predetermined first and/or second maximum distance from the superimposed surface position data points; and/or
an iteration module which is configured to iterate at least the reduction step on the basis of a reduced fitting function through surface position data points superimposed and reduced by the reduction module as the surface function and on the basis of the superimposed and reduced surface position data points.

The modules are configured to perform each of the method steps described in relation to the method. The modules may be designed as software modules.

One aspect relates to a computer program product comprising computer-readable program parts which, when loaded and executed, cause an apparatus according to the above-described aspect to perform a method according to the above-described aspect, wherein the computer program product at least partially controls and/or regulates at least one of the following units:
the scanner; and/or
the mirroring module; and/or
the fitting function ascertaining module; and/or
the face form angle ascertaining module; and/or
the tilting module; and/or
the optimization module; and/or
the reduction module; and/or
the iteration module.

The computer program product may be designed as a control software. The computer program product may be designed at least for controlling the software modules used for evaluation. In addition, it may be designed to send a starting signal to the scanner and to obtain measurement data from the scanner, from which the computer program product obtains and/or can calculate the first and second surface position data points.

Within the scope of this invention, the terms “substantially” and/or “about” may be used so as to include a deviation from up to 5% from a numerical value following the term, a deviation of up to 5° from a direction following the term and/or from an angle following the term.

Unless otherwise specified, terms such as top, bottom, above, below, lateral etc. refer to the Earth's reference system in an operating position of the subject matter of the invention.

### BRIEF DESCRIPTION OF THE DRAWINGS

The invention is described in more detail below based on exemplary embodiments shown in figures. Here, the same or similar reference signs may designate the same or similar features of the embodiment. Individual features shown in the figures may be implemented in other exemplary embodiments. Shown are:

FIG. 1 in a graph, scanned first and second surface position data points of spectacles;

FIG. 2 in a graph, superimposed surface position data points through which a fitting function is applied;

FIG. 3 in a graph, superimposed surface position data points tilted in an optimized manner through which an optimized fitting function is applied;

FIG. 4 in a graph, superimposed and reduced surface position data points through which a reduced fitting function is applied;

FIG. 5 in a graph, first and second minimized surface position data points, wherein the first minimized surface position data points are mirrored back to their original side, wherein through the first minimized surface position data points, a first minimized fitting function is applied as a first surface function, and through the second minimized surface position data points, a second minimized fitting function is applied as a second surface function; and

FIG. 6 in a flowchart, an exemplary embodiment of a method for ascertaining a face form angle.

### DETAILED DESCRIPTION

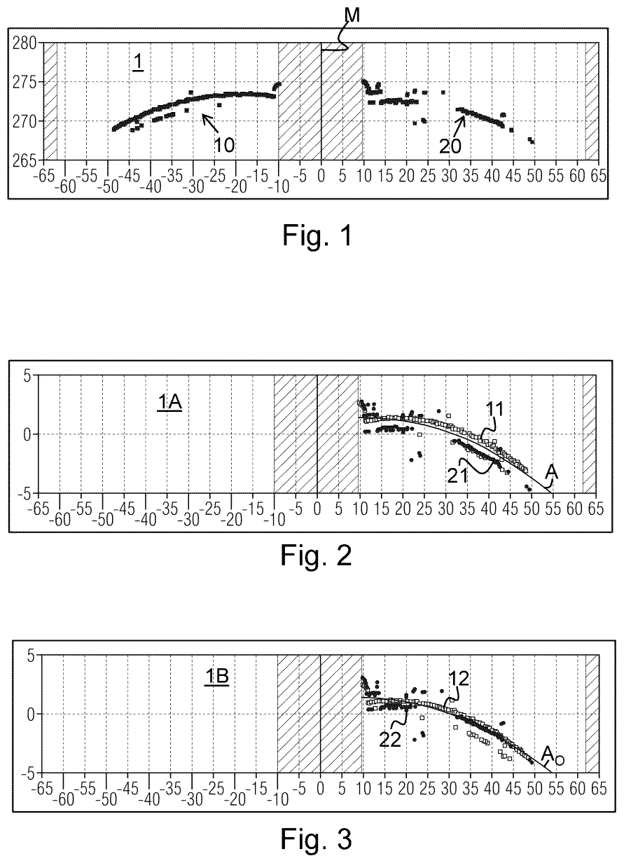

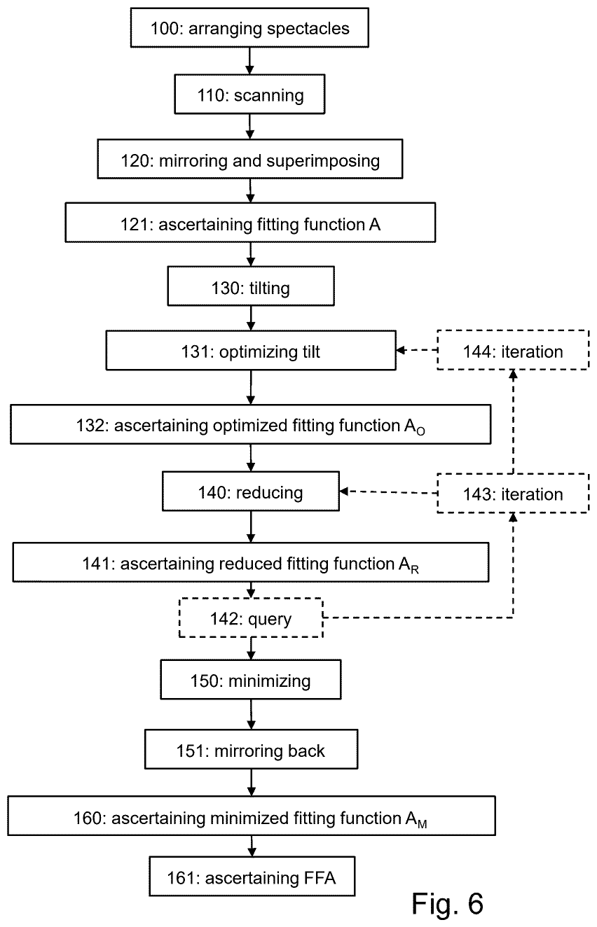

In the figures, an exemplary embodiment of a method for measuring the face form angle of spectacles is shown and visualized. Here, FIG. 6 shows individual steps of the method in a flowchart. FIGS. 1 to 5 each show surface position data points of a dataset which are input into a graph, respectively, and ascertained and/or used while performing the method.

The method according to the invention does not necessarily have to include all method steps shown in FIG. 6, since some of the method steps shown in FIG. 6 are optional. Furthermore, the method may include additional method steps which are not shown in FIG. 6.

In the method step 100 shown in FIG. 6, the spectacles to be measured having first and second spectacle lenses are arranged in the measurement field of a scanner. For this purpose, the spectacles, arranged in this manner, may be applied to a spectacle receptacle such that the front surfaces of both spectacle lenses of the spectacles face the scanner.

Subsequently, in method step 110, the spectacles are scanned, wherein in particular the two front surfaces, also called spectacle lens surfaces, of the first spectacle lens and the second spectacle lens of the spectacles are scanned by the scanner. Here, the spectacle receptacle may be arranged relative to the scanner such that the beams of the scanning light of the scanner are incident on the two front surfaces of the spectacles approximately perpendicularly. The spectacle receptacle and/or the scanner may be calibrated such that surface position data points of the spectacle lens surface can be generated by the scanner, e.g., by means of triangulation. The surface position data points may be generated, e.g., as 2D coordinates.

Here, the scanner may be designed as a laser scanner, e.g. as a line laser scanner. The scanner generates at least one dataset 1 which has the surface position data points. These surface position data points contain coordinates at which reflections of the scanning light have occurred during scanning in method step 110. From these reflections, the scanner registers, in method step 110, reflection signals which, in turn, are converted to the surface position data points.

FIG. 1 shows, in a graph, the dataset 1 acquired by the scanner, having first surface position data points 10 and second surface position data points 20. The first and second surface position data points 10 and 20 of the dataset 1 are plotted in a graph shown in FIG. 1. Through the zero point along the x-axis of the graph, a central plane M runs with respect to which the spectacles are designed to be substantially symmetrical. In the negative range of the x-axis, the first spectacle lens is arranged during scanning. Therefore, this negative x-range is also referred to as a first spectacle half. In the positive range of the x-axis, the second spectacle lens is arranged during scanning. Therefore, this positive x-range is also referred to as a second spectacle half.

During scanning 110, the scanner does not generate any surface position data points which are arranged closer than about 10 mm, e.g., on the central plane M. Likewise, it does not generate any surface position data points in a range which is further away than about 50 mm, e.g., from the central plane M. The scanner thus only generates surface position data points which are spaced apart from the central plane M at least by a nasal distance (about 10 mm in the example) and/or which are spaced apart from the central plane M at most by a temporal distance (about 50 mm in the example).

At the X-axis of the graphs shown in FIGS. 1 to 5, the corresponding distance from the central plane M is indicated in millimeters.

On the Y-axis of the graphs shown in FIGS. 1 to 5, the height profile of the spectacle lenses is indicated, e.g., in millimeters. Here, in some of the graphs shown in FIGS. 1 to 5, slightly shifted and/or differently scaled y-axes are shown.

In the measurement data of the dataset 1 shown by way of example in FIG. 1, in particular in the first surface position data points 10, in addition to reflection signals along the spectacle lens surface of the first spectacle lens, a plurality of interfering reflection signals is shown, which are probably caused by the spectacle lens back surface of the first spectacle lens. In the second surface position data points shown in FIG. 1, a plurality of reflection signals is shown, which are presumably caused by noise and/or a disturbance and which presumably have not been actually reflected from the spectacle lens surface of the second spectacle lens. However, most of the surface position data points 10 and 20 contained in the dataset 1 are presumably actually caused by the two spectacle lens surfaces of the spectacles and therefore allow to draw conclusions about the face form angle.

In a method step 120, the first surface position data points 10 are now mirrored with respect to the central plane M from the first spectacle half (that is, from the negative x-range) to the second spectacle half (that is, to the positive x-range). This may, e.g., be done simply by changing the sign of the x-coordinate of each first surface position data point 10. When being mirrored, all surface position data points are thus mirrored to the second spectacle half, that is, to the positive x-range in the example.

FIG. 2 shows, in a graph, a superimposed dataset 1A obtained thereby, which comprises both superimposed first surface position data points 11 and superimposed second surface position data points 21. Here, the superimposed second surface position data points 21 are indicated by filled boxes. They may substantially correspond to the second surface position data points 20 shown in FIG. 1. The superimposed first surface position data points 11 are indicated by empty boxes in FIG. 2. They may substantially correspond to the first surface position data points 10 shown in FIG. 1 with the sign of the x-coordinate changed.

In a method step 130 subsequent thereto, the superimposed first surface position data points 11 are tilted with respect to the superimposed second surface position data points 21. By tilting, an error which may result from spectacles being asymmetrically set on the spectacle receptacle can be compensated for. Here, a tilt angle by which the tilting is effected may be a one-digit number of degrees or even only a fraction of one degree. Such a small tilt angle may be sufficient to superimpose the surface position data points 11 and 21 of the superimposed dataset 1A substantially congruently and/or mostly coincidently.

In a subsequent method step 131, the tilt is optimized, e.g. by means of a best fit approach, in such a way that the superimposed first and second surface position data points 11 and 21 are superimposed as coincidently and/or congruently as possible.

FIG. 3 shows, in a graph, an optimized dataset 1B which results from the optimization of the tilt in method step 131. Here, the optimized dataset 1B comprises first surface position data points 12 tilted in an optimized manner (indicated by empty boxes in FIG. 3) and second surface position data points 22 tilted in an optimized manner (indicated by filled boxes in FIG. 3) which, in turn, are each based on the originally generated first and second surface position data points 10 and 20.

In a method step 132, an optimized fitting function Ao is applied through all of these superimposed first and second surface position data points 12 and 22 tilted in an optimized manner. In the exemplary embodiment, an optimized fitting polynomial may be used for this purpose, which is why the optimized fitting function Ao is also referred to below as an optimized fitting polynomial Ao.

The method may further be continued on the basis of the optimized fitting polynomial A_{O} thus ascertained and the optimized first dataset 1B.

In a subsequent method step 140, as a reduction step, reduction of the surface position data points 12 and 22 of the optimized dataset 1B is carried out. Here, so-called “outliers” are eliminated and/or filtered out from the optimized dataset 1B. Here, in particular those surface position data points 12 and 22 which are arranged further away from the optimized fitting polynomial Ao than a predetermined first maximum distance may be removed from the optimized dataset 1B. As a first maximum distance, e.g., a distance of about 0.3 mm may be used.

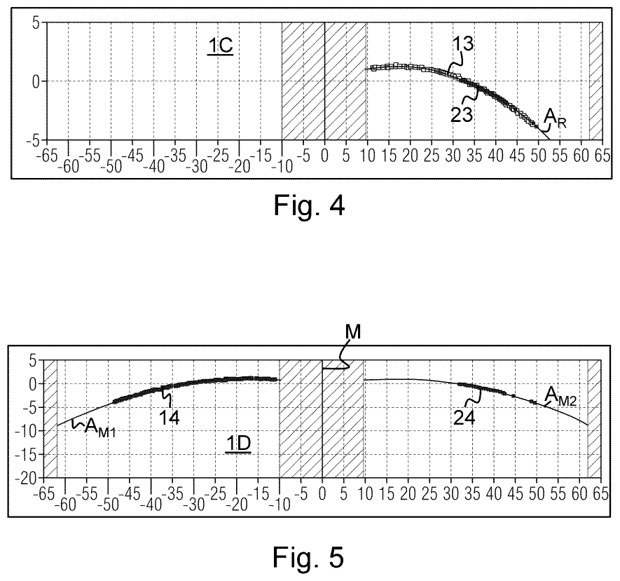

FIG. 4 shows, in a graph, a reduced dataset 1C which has superimposed and reduced first surface position data points 13 (indicated by empty boxes in FIG. 4) and superimposed and reduced second surface position data points 23 (indicated by filled boxes in FIG. 4). The reduced dataset 1C is cleansed from those “outliers” which were arranged further away from the fitting polynomial Ao than the first maximum distance in the optimized dataset 1B. Through the surface position data points 13 and 23 of the dataset 1C thus reduced, a reduced fitting function AR is applied in a method step 141. In the exemplary embodiment, a reduced fitting polynomial may be used for this purpose, which is why the reduced fitting function AR is also referred to below as reduced A_{O}.

Subsequently to ascertaining the reduced fitting polynomial AR, the method may be continued, e.g. with minimization in method step 150. This may be done in particular when a query 142 shows that in the reduction step 140, not a single surface position data point had to be filtered out from the optimized dataset 1B anymore to obtain the reduced dataset 1C.

As an alternative, in particular when the query 142 shows that in the reduction step 140, at least one surface position data point has been filtered out, an iteration 143 or 144 may be carried out subsequently.

Depending on the embodiment, either an iteration of method steps 140, 141 and, e.g., 142 may be carried out in method step 143 or an iteration of method steps 131, 132, 140, 141 and, e.g., 142 may be carried out in method step 144.

The iteration 143 and 144 comprises at least the reduction step 140, wherein here, only those surface position data points which are arranged further away from the reduced fitting polynomial AR than the first maximum distance are filtered out and removed. Likewise, the repeated generation of the reduced fitting polynomial AR in method step 141 is iterated on the basis of the dataset 1C thus reduced again. The reduction step 140 may be iterated until no further surface position data points have to be eliminated anymore, which may be checked, e.g., as part of the query 142.

As an alternative to the iteration step 143, in an iteration step 144, not only may an iteration of the reduction step 140 be carried out, but the iteration may even start previously when optimizing the tilt in method step 131. Here, only the surface position data points of the reduced dataset 1C are considered, from which outliers have already been filtered out.

Subsequently, all method steps subsequent thereto may be performed, that is, method step 132 in which an optimized fitting polynomial A_{O} (in general: an optimized fitting function) is ascertained again, and method steps 140 to 142. The iteration 144, including the optimization of the tilt (method step 131) in the iteration, improves the achieved result even more and thus even more reliably leads to the calculation of the actual face form angle.

Subsequently to the query 142, in method step 150, minimization may be carried out. Here, similarly to the reduction step 140, “outliers” are removed once again. Here, however, a smaller second maximum distance is taken into account instead of the first maximum distance. During minimization, all surface position data points which are arranged further away from the reduced fitting polynomial AR than the second maximum distance which, e.g., may be designed to be half the first maximum distance, are removed from the reduced dataset 1C. The result provides a minimized dataset which comprises minimized first and second surface position data points (not shown in the figures). Visually, the dataset thus minimized looks similar to the reduced dataset 1C shown in FIG. 4.

In subsequent method step 151, mirroring-back of the minimized first surface position data points about the central plane M back to the first spectacle half may be carried out, that is, in the negative x-range in the example.

When mirroring back the minimized first surface position data points in method step 151, the tilt and/or the tilt angle may be taken into account so as to mirror back the surface position data points to their correct positions.

FIG. 5 shows the data points after being mirrored back. Here, a minimized and mirrored-back dataset 1D is the result. The minimized and mirrored-back dataset 1D comprises minimized and mirrored-back first surface position data points 14 and minimized second surface position data points 24, wherein in FIG. 5, all minimized and mirrored-back surface position data points 14 and 24 are indicated by filled boxes.

Through the minimized and mirrored-back dataset 1D, two fitting functions are applied, namely a first minimized fitting function A_{M1} through the minimized and mirrored-back first surface position data points 14 as a first surface function for the first spectacle lens and a second minimized fitting function A_{M2} through the minimized second surface position data points 24 as a second surface function for the first spectacle lens. The ascertainment of these minimized fitting functions A_{M1} and A_{M2} may be carried out in a method step 160.

In the exemplary embodiment, minimized fitting polynomials may be used for this purpose, which is why the minimized fitting functions are also referred to below as first and second minimized fitting polynomials A_{M1} and A_{M2}.

As an alternative to ascertaining the first and second minimized fitting polynomials A_{M1} and A_{M2}, only a single minimized fitting function A_{M} (not shown in the figures, referred to below as a minimized fitting polynomial A_{M} by way of example) may also be ascertained by the (not yet mirrored-back, but still superimposed) minimized first surface position data points and the minimized second surface position data points. Here, the minimized fitting polynomial A_{M} is ascertained only for the superimposed and minimized surface position data points in the second spectacle half. The minimized fitting polynomial A_{M} may be used as the second surface function for the second spectacle lens. The minimized fitting polynomial A_{M} may be mirrored back to the first spectacle half with respect to the central plane M (instead of the minimized first surface position data points) to form the first surface function for the first spectacle lens there.

In method step 170, at least one face form angle is ascertained. Preferably, first and second face form angles may be ascertained for the first and second spectacle lens, e.g. on the basis of the first and second surface functions. The face form angle is ascertained on the basis of one of the fitting polynomials. For this, either the normal fitting polynomial A, the optimized fitting polynomial Ao, the reduced fitting polynomial A_{R}, or preferably at least the minimized fitting polynomial(s), that is, e.g., the minimized fitting polynomial A_{M} or the first minimized fitting polynomial A_{M1} and the second minimized fitting polynomial A_{M2}, may be used. More generally, one of the corresponding fitting functions may be used for this.

The method reliably provides good results for the geometrical face form angle. By the tilting 130 and/or the optimization of the tilt in method step 131, a possible tilt of the spectacle frame on the spectacle receptacle is virtually eliminated. Here, the tilt is adapted to the fitting polynomial currently used.

The filtration of the measurement data by the reduction step 140 is preferably carried out iteratively. Here, in an iteration loop, the optimization of the tilt (method step 131), the calculation of the fitting polynomial (method step 132 and/or 141), and the reduction of the measurement values (method step 140) may be repeated and calculated until the maximum deviation of the remaining and filtered surface position data points no longer exceeds the first maximum distance and/or the second maximum distance.

In most cases, in one attempt in at least 97% of cases, the final calculation of the face form angle can be taken as the actual face form angle without remeasurements by an operator. As a result, manual remeasurement of the face form angle, which has often been necessary until now, is omitted in almost all cases.

### LIST OF REFERENCE NUMERALS

1 dataset
1A superimposed dataset
1B superimposed dataset tilted in an optimized manner
1C reduced dataset
1D minimized and mirrored-back dataset
10 first surface position data points
11 superimposed first surface position data points
12 first surface position data points tilted in an optimized manner
13 reduced first surface position data points
14 minimized and mirrored-back first surface position data points
20 second surface position data points
21 superimposed second surface position data points
22 second surface position data points tilted in an optimized manner
23 reduced second surface position data points
24 minimized second surface position data points
100 arranging spectacles
110 scanning
120 mirroring and superimposing
121 ascertaining fitting polynomial
130 tilting
131 optimizing tilt
132 ascertaining optimized fitting polynomial
140 reducing
141 ascertaining reduced fitting polynomial
142 query
143 iteration of reduction step
144 iteration of optimization and reduction step
150 minimizing
151 mirroring back
160 ascertaining minimized fitting polynomial
161 ascertaining FFA
A fitting polynomial
A_{O} optimized fitting polynomial
A_{R} reduced fitting polynomial
A_{M} minimized fitting polynomial
A_{M1} first minimized fitting polynomial
A_{M2} second minimized fitting polynomial
M central plane

1-15. (canceled)

16. A method for measuring a face form angle of spectacles, comprising:
arranging the spectacles, which have a first spectacle lens and a second spectacle lens, on a spectacle receptacle;
scanning the spectacle lens surfaces of both spectacle lenses of the spectacles using a scanner for generating first surface position data points of the first spectacle lens and second surface position data points of the second spectacle lens;
mirroring the first surface position data points of the first spectacle lens onto the second surface position data points of the second spectacle lens with respect to a central plane between the two spectacle lenses such that the first and second surface position data points of both spectacle lenses are superimposed;
ascertaining a fitting function as a surface function through the superimposed surface position data points of both spectacle lenses; and
ascertaining the face form angle using the surface function through the superimposed surface position data points of both spectacle lenses.

17. The method according to claim 16, wherein in the superimposed surface position data points, the first surface position data points are tilted with respect to the second surface position data points such that the first and second surface position data points are arranged more closely to the ascertained surface function.

18. The method according to claim 17, wherein the tilt of the first surface position data points with respect to the second surface position data points is optimized in such a way that the superimposed first and second surface position data points are arranged as closely as possible to an optimized fitting function as the surface function through the surface position data points, superimposed over each other and tilted in an optimized manner, of both spectacle lenses.

19. The method according to claim 16, wherein in a reduction step, individual surface position data points whose distance from the surface function is greater than a predetermined first maximum distance are removed from the superimposed and possibly tilted surface position data points so as to obtain superimposed and reduced surface position data points.

20. The method according to claim 19, wherein a reduced fitting function is ascertained as a surface function through the superimposed and reduced surface position data points of both spectacle lenses.

21. The method according to claim 20, wherein at least the reduction step is iterated based on the reduced fitting function as the surface function and based on the reduced superimposed surface position data points.

22. The method according to claim 19, wherein individual surface position data points whose distance from the surface function is greater than a predetermined second maximum distance are removed from the superimposed and reduced surface position data points, wherein the second maximum distance is designed to be smaller than the first maximum distance so as to obtain minimized surface position data points.

23. The method according to claim 22, wherein a minimized fitting function is ascertained as the surface function through the minimized surface position data points of both spectacle lenses.

24. The method according to claim 16, wherein the face form angle is ascertained based on the surface function which corresponds to one of the following fitting functions:
a) optimized fitting function,
b) reduced fitting function, or
c) minimized fitting function.

25. The method according to claim 16, wherein a fitting polynomial is ascertained as a fitting function.

26. The method according to claim 25, wherein the fitting polynomial is ascertained as the fitting function, and:
a) an optimized fitting polynomial as an optimized fitting function, and/or
b) a reduced fitting polynomial as a reduced fitting function, and/or
c) a minimized fitting polynomial as a minimized fitting function.

27. The method according to claim 16, wherein prior to ascertaining the face form angle for the first spectacle lens, the remaining first surface position data points are mirrored back to the associated side of the spectacles.

28. The method according to claim 16, wherein the surface position data points are ascertained two-dimensionally.

29. An apparatus for measuring a face form angle of spectacles, comprising:
a spectacle receptacle to receive the spectacles which have a first spectacle lens and a second spectacle lens;
a scanner to scan the spectacle lens surfaces of both spectacle lenses of the spectacles arranged on the spectacle receptacle and to generate first surface position data points of the first spectacle lens and second surface position data points of the second spectacle lens;
a mirroring module to mirror the first surface position data points of the first spectacle lens onto the second surface position data points of the second spectacle lens with respect to a central plane between the two spectacle lenses such that the first and second surface position data points of both spectacle lenses are superimposed;
a fitting function ascertaining module to ascertain a fitting function as a surface function through the superimposed surface position data points of both spectacle lenses; and
a face form angle ascertaining module to ascertain the face form angle using the surface function through the superimposed surface position data points of both spectacle lenses.

30. The apparatus according to claim 29, comprising:
a tilting module which is configured, in the superimposed surface position data points, to tilt the first surface position data points with respect to the second surface position data points such that the first and second surface position data points are arranged more closely to the ascertained surface function; and/or
an optimization module which is configured to optimize the tilt of the first surface position data points with respect to the second surface position data points in such a way that the superimposed first and second surface position data points are arranged as closely as possible to an optimized fitting function as the surface function through the surface position data points, superimposed over each other and tilted in an optimized manner, of both spectacle lenses; and/or
a reduction module which is configured, in a reduction step, to remove individual surface position data points whose distance from the surface function is greater than a predetermined first and/or second maximum distance from the superimposed surface position data points; and/or
an iteration module which is configured to iterate at least the reduction step based on a reduced fitting function (AR) through surface position data points superimposed and reduced by the reduction module as the surface function and based on the superimposed and reduced surface position data points.

31. A computer program product comprising computer-readable program parts which, when loaded and executed, cause the apparatus according to claim 30 to perform a method for measuring a face form angle of spectacles, comprising:
arranging the spectacles, which have a first spectacle lens and a second spectacle lens, on a spectacle receptacle;
scanning the spectacle lens surfaces of both spectacle lenses of the spectacles using a scanner for generating first surface position data points of the first spectacle lens and second surface position data points of the second spectacle lens;
mirroring the first surface position data points of the first spectacle lens onto the second surface position data points of the second spectacle lens with respect to a central plane between the two spectacle lenses such that the first and second surface position data points of both spectacle lenses are superimposed;
ascertaining a fitting function as a surface function through the superimposed surface position data points of both spectacle lenses; and
ascertaining the face form angle using the surface function through the superimposed surface position data points of both spectacle lenses,
wherein the computer program product at least partially controls and/or regulates the scanner and/or the mirroring module and/or the fitting function ascertaining module and/or the face form angle ascertaining module and/or the tilting module and/or the optimization module and/or the reduction module and/or the iteration module.
